(19) United States
(12) Patent Application Publication
(10) Pub. No.: US 2022/0164822 A1
(43) Pub. Date: May 26, 2022

(54) System and method for a game involving the production and transmitting of live performances of selected behaviors

(71) Applicant: Gregory A. Piccionielli, Westlake Village, CA (US)

(72) Inventor: Gregory A. Piccionielli, Westlake Village, CA (US)

(21) Appl. No.: 17/578,251

(22) Filed: Jan. 18, 2022

Related U.S. Application Data
(63) Continuation of application No. 13/815,739, filed on Mar. 15, 2013, now abandoned.
(60) Provisional application No. 61/611,509, filed on Mar. 15, 2012.

(51) Int. Cl. G06Q 30/02

(52) U.S. Cl. CPC G06Q 30/0239

(57) ABSTRACT

In a method for producing a transmission of a live performance of a selected behavior, a potential participant in a live performance is identified. An image of the potential applicant is posted on a website and associated with at least one behavior. One or more on-line viewers of the website then provide a contribution to a pool from which a reward is to be provided upon performance of at least one specified behavior specified. The potential participant is prompted to perform at least one specified behavior specified, and a reward is associated with each suggested behavior. A live view of a performance by the potential participant of at least one specified behavior is transmitted to the website, at which point the potential participant becomes an actual participant in the live performance. The actual participant is then provided with a reward associated with the performed specified behavior.

This application is based on U.S. Provisional Patent Application Ser. No. 61/611,509 (attorney docket no. GAP-12003USV), filed Mar. 15, 2012, the entire disclosure of which is incorporated herein by reference and from which priority is claimed.

### FIELD OF THE INVENTION

The present invention relates to systems and methods for on-line tracking of speculation regarding the probable occurrence of selected behaviors transmitted via live on-line means. The present invention relates to systems and methods for encouraging and rewarding such occurrences.

### BACKGROUND OF THE INVENTION

“Reality”-type video content depicting non-professional actors and actresses engaging in various unusual or extreme behaviors have become popular. For example, in the “Girls Gone Wild”® video series, young and attractive women are encouraged to remove articles of clothing and to appear in a state of semi-nudity (typically topless). Frequently, the women appearing in such videos do so very willingly and need little if any enticement to do so. In some instances, however, participants may be reluctant to engage in the desired extreme behavior, such as clothing removal or the taking of a photograph of a private part for publication via the World Wide Web. In such cases, additional incentives may prove necessary or helpful.

In addition to pre-recorded reality video content, live reality content is also becoming popular. In many cases such live reality content provides a more realistic experience for the viewer than similar pre-recorded content. Live reality content provided via an interactive means via the Internet affords the possibility of real-time interaction between a participant and a programming producer, interviewer, viewer, challenger or the like, as well as between the participant and a viewing audience, in particular an on-line viewing audience.

On-line gaming and on-line gambling are also quite popular.

A need exists for a system and method for producing live content, more particularly live content viewable over a network such as the Internet, in which participants engage in unusual or extreme behaviors, such as clothing removal.

A need also exists for a system and method for producing such live content in which a viewing audience (e.g., one or more on-line viewers) are enabled to participate in the behavior by, for example, providing or voting on suggested behaviors, offering premiums such as cash rewards for a person to engage in suggested behaviors, and/or wagering on the occurrence of suggested or incentivized behaviors.

A need also exists for a system whereby one or more persons are provided with an on-line means to speculate, for fun or in association with a wager or money pool, whether certain specified possible outcomes of live behavior or other human actions broadcast via the World Wide Web or other computer network of such persons, which are prompted by a prompting person, will occur, and then such persons are also provided with a means to view whether such behaviors or actions have or have not occurred.

### SUMMARY OF THE PREFERRED EMBODIMENTS

In accordance with one aspect of the present invention, there is provided a method for producing a transmission of a live performance of a selected behavior. The method includes the steps of: identifying a potential participant in a live performance; posting an image of the potential participant on a website; associating the posted image with at least one behavior; accepting from at least one on-line viewer of the website a contribution to a pool from which a reward is to be provided upon performance of at least one associated behavior; suggesting to the potential participant performance of at least one associated behavior and associating a reward with each behavior so suggested; transmitting to the website a live view of a performance by the potential participant of at least one suggested behavior, whereby the potential participant becomes an actual participant in the live performance; and providing to the actual participant a reward associated with the at least one behavior so performed.

Some potential participants may initially be reluctant to perform a suggested behavior. Thus, in particular embodiments, on-line viewers provide additional contributions to the pool in order to increase the reward to be provided to the potential participant upon performance of one or more behaviors. When the reward increases to an amount sufficient to induce the potential performer to perform one or more behaviors, the potential participant performs as discussed above, and receives the increased reward.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating a particular embodiment of a method according to the invention, and

FIG. 2 is a depiction of a web page provided by a site on a network, such as the Internet, for practicing embodiments of methods according to the invention.

Like numerals refer to like parts throughout the several views of the drawings.

### DETAILED DESCRIPTION OF THE PREFERRED EMBODIMENTS

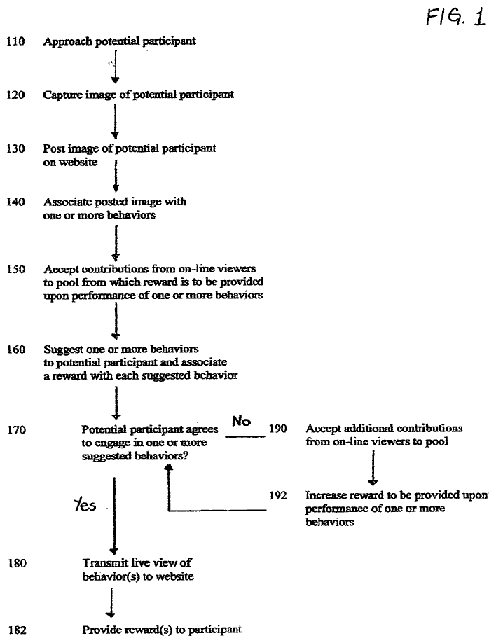

Referring to FIG. 1, a program producer (e.g., a “finder” or “jockey”) approaches a potential participant (step 110), in either a public or private location. In certain particular embodiments, the program producer carries a mobile phone, computer or other video, audio, audio transmission device capable of transmitting audio, video, and/or haptic information regarding a live event to a website, for display to viewers of the website. In other particular embodiments, the producer is accompanied by one or more support personnel, including one or more camerapersons, soundpersons, technicians, actors, etc., and the support personnel produce the transmission or assist in the production of the transmission.

The potential participant is identified by the program producer by any desired procedure. For example, the program producer, in some embodiments, visually identifies a potential participant, using criteria such as sex, physical attractiveness, attire, vocal characteristics, etc. In additional embodiments, the program producer identifies a potential participant as a member of an organization, in particular an organization whose members desire to participate in unusual or extreme behaviors for transmission to a website maintained by or affiliated with the organization. Methods useful for identifying and contacting such potential participants are described, for example, in U.S. patent application Ser. No. 13/317,622, to Piccionelli et al.

In some preferred embodiments, the potential participant is in a public place and may be freely photographed or videographed, and such photograph or videograph may be uploaded to the website at which one or a plurality of on-line viewers can engage in speculation whether the finder or jockey can directly or with the help of the on-line viewers entice or encourage the potential participant to engage in a particular behavior.

In some preferred embodiments, if there is interest by the on-line viewers, the finder or jockey approaches the potential participant to present one or more propositions to engage in one or more specified behaviors (e.g., give the finder or jockey the potential participant's name, give the finder or jockey a kiss, bare his or her breasts or other private parts in front of the jockey's or finder's camera or other device broadcasting to the on-line viewers, go into a public restroom to take a picture, video or haptic recording of a private part and upload it to the website at which the on-line viewers will be able to view or otherwise experience the recording, etc.).

Once the finder or jockey has approached the potential participant, he captures an image of him or her (step 120), either personally by use of a camera or other device in his possession, or by the agency of one or more support personnel as mentioned above. A plurality of images can be captured in alternative specific embodiments. The program producer then posts the image of the potential participant on the website (step 130). In alternative embodiments, for example embodiments in which the potential participant is part of an organization as mentioned above, the program producer posts an image obtained from the organization in addition to, or in place of, an image or images captured in step 120.

The posted image is then associated on the website with a list of one or more suggested behaviors for the potential participant to engage in (step 140). Non-limiting examples of suggested behaviors include speaking to the program producer, another potential participant or a passer-by; kissing the program producer or another potential participant; removing some or all of the potential participant's clothing; flashing or mooning; singing; dancing; playing a musical instrument; consuming one or more foods or beverages; etc.

Viewers of the website are enabled to bid or wager on whether certain specified behavior or behaviors, such as those in which they desire to see the potential participant engage, will occur. Thus, the viewers are enabled to provide contributions, which can be monetary contributions or any other valuable consideration, to a pool from which a reward is provided upon performance of a particular behavior (step 150). For example, a viewer, in certain embodiments, bids or contributes a specific dollar amount for the performance of a selected behavior, such as removal of the potential participant's top. All viewers who bid on such a performance contribute to the pool associated with that performance. Viewers are enabled, in specific embodiments, to bid on some or all of the suggested behaviors provided on the website. In further specific embodiments, viewers are enabled to suggest additional behaviors and to bid on those behaviors as well.

In some preferred embodiments the finder, jockey or other program producer asks the potential participant if she desires to engage in one or more of the suggested behaviors, and, to encourage her participation, informs her that a reward is associated with each suggested behavior (step 160). In particular embodiments, the program producer further advises the potential participant that viewers of the website desire to watch her performance(s), and have contributed to the reward(s).

The potential participant now is given the choice of whether or not to engage in one or more of the suggested behaviors (step 170). If the potential participant now agrees to engage in one or more of the suggested behaviors, her performance is transmitted to the website for viewing by the website's viewers (step 180). For each suggested behavior in which she engages, she is then provided with a corresponding reward (step 182). The reward(s) can be provided, for example, in the form of cash provided directly from the program producer to the (now actual) participant; electronic payment to an account, such as a PayPal® account; a coupon or certificate redeemable by the participant for a stated premium, in cash, goods, services, etc.; or any other desired form. In some particular embodiments, all or substantially all of the pooled contributions associated with the completed behavior(s) are provided to the participant. In other particular embodiments, the participant is provided with a portion of the pooled contributions, with the remainder being distributed among one or more of the finder, jockey or program producer, on-line wagerers, website operator(s), affiliated organizations, and/or other individuals or organizations.

In some preferred embodiments, if the potential participant is reluctant to engage in any of the suggested behaviors, viewers are enabled to provide additional contributions to increase the pool(s) associated with one or more of the suggested behaviors (step 190). The program producer (finder, jockey, etc.), in particular embodiments, informs the potential participant that her reward for engaging in one or more of the suggested behaviors has now increased (step 192). She is then afforded another opportunity to engage in one or more of the suggested behaviors. Depending on the willingness or reluctance of the potential participant, additional contributions can be obtained repeatedly, until the reward(s) reach a level at which the potential participant's reluctance is overcome and she agrees to engage in the behavior(s). Once she has done so, she is provided with the appropriate reward(s) as mentioned above.

In the foregoing embodiments, the participant, and optionally the program producer and/or additional individuals or organizations, are rewarded when one or more of the suggested behaviors are engaged in. According to alternative embodiments, viewers of the website are also enabled to wager on whether or not the potential participant will engage in one or more of the suggested behaviors, and, upon a successful wager, to receive an appropriate payout. In very particular embodiments, odds are assigned to some or all of the suggested behaviors, and on-line viewers are paid in accordance with the odds for each such behavior.

In the foregoing embodiments, the program producer approaches a potential participant. In alternative embodiments, one or more potential participants approach the program producer and request to participate.

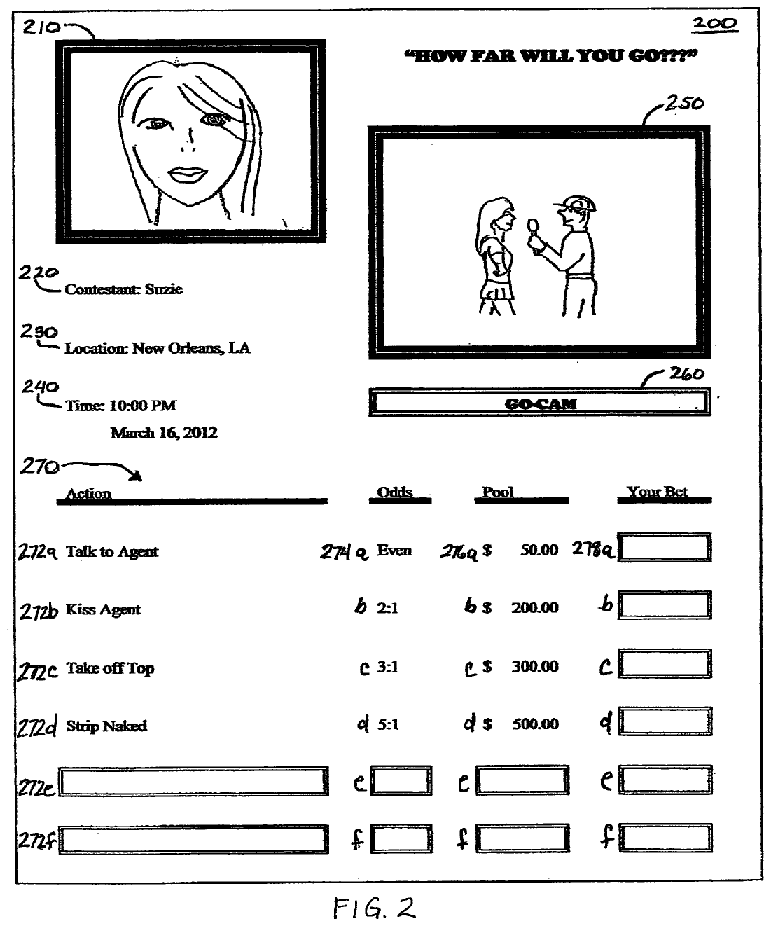

Turning now to FIG. 2, a web page 200 useful in practicing embodiments of the inventive method such as are described above is provided. Web page 200, entitled “How Far Will You Go??”, includes first window 210 to which a captured image of a potential participant is provided. Captions 220, 230, 240 provide the potential participant's name (220) and location (230), as well as the date and time (240). Second window 250 displays a transmission of the potential participant, and optionally in those embodiments employing support personnel, the program producer interacting with her (as shown). When the program producer (e.g., the finder) himself produces the transmission of the potential participant, he will typically not appear in the transmission displayed in second window 250. Caption 260 indicates the origin of the transmission displayed in second window 250 (as shown, the “Go-Cam”).

Below the first and second windows, table 270 provides a listing of suggested behaviors 272a-d (as shown, “Talk to Agent” (e.g., program producer, other participant, etc.), “Kiss Agent”, “Take Off Top”, “Strip Naked”), with their associated odds 274a-d, as well as the total of pool contributions 276a-d provided by viewers for each suggested behavior. In particular embodiments, additional spaces (two are show, spaces 272e-f) are provided for viewers to submit further suggested behaviors. When such spaces are provided, corresponding spaces for odds and pool totals are also provided. To the right, spaces 278a-f are provided for use by viewers in submitting contributions (or, placing bets) corresponding to each suggested behavior. When a user clicks on one or more of spaces 278a-f, he is re-directed to a second page (not shown) on which he is enabled to arrange for payment of the stated contribution/bet, for example, by means of an electronic transfer or other desired payment method.

In some preferred embodiments where odds are assigned to the possible outcomes of the question of whether the participant will or will not engage in specified behavior, the historic track record of the finder is displayed as a factor influencing the outcome to assist viewers in making appropriate wagers or fun predictions regarding the outcome. In this way the finder's track record is useful to gamblers in a way analogous to a jockey's record regarding the evaluation of whether a particular horse being ridden by a particular jockey has a greater or lesser chance of winning a horse race.

It is to be understood that the embodiments set forth herein should not be viewed or interpreted as limiting. The “How far will you go?” concept set forth in this application is applicable to virtually any type of human behavior that can be incentivized by monetary or other means.

It is to be understood as well that in some embodiments the program producer may provide to a similar website as that described above, audio, visual or audiovisual events that can be similarly speculated on without any incentives provided. For example, transmission of a video of a man sitting on a park provokes wagers at the website regarding when the man will get up. Similarly, live video of a man perched atop a building threatening to jump can provide an even greater amount of speculative drama.

What is claimed is:

1. A method for producing a transmission of a live performance of a selected behavior, the method comprising the steps of:
a) identifying a potential participant in a live performance,
b) posting an image of the potential participant on a website,
c) associating the posted image with at least one behavior,
d) accepting from at least one on-line viewer of the website a contribution to a pool from which a reward is to be provided upon performance of at least one behavior specified in step c),
e) suggesting to the potential participant performance of at least one behavior specified in step c) and associating a reward with each suggested behavior,
f) transmitting to the website a live view of a performance by the potential participant of at least one behavior specified in step c), whereby the potential participant becomes an actual participant in the live performance, and
g) providing to the actual participant of step f) a reward associated with the at least one behavior performed in step f).
